(19) United States
(12) Patent Application Publication
(10) Pub. No.: US 2009/0153436 A1
(43) Pub. Date: Jun. 18, 2009

(54) MULTIFUNCTIONAL DISPLAY APPARATUS

(75) Inventors: Bo JU, Suwon-si (KR); Jong-Keol SHIN, Yongin-si (KR); Sang-Min BAE, Suwon-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/333,636

(22) Filed: Dec. 12, 2008

(30) Foreign Application Priority Data
Dec. 14, 2007 (KR) 10-2007-0131145

(51) Int. Cl. G09G 5/00

(52) U.S. Cl. 345/1.3

(57) ABSTRACT

A multifunctional display apparatus including a plurality of unit display modules is provided. The multifunctional display apparatus includes two or more unit display modules, one or more electrical connection units, and one or more sensing units. The unit display modules each include a Liquid Crystal Display (LCD). The electrical connection units electrically connect the unit display modules in such a way that the unit display modules are movable and are not separated from each other. The sensing units are installed at each of the unit display modules to sense the other neighboring unit display module, so that the corresponding functions are executed according to various transforms of the unit display modules.

### PRIORITY

This application claims the benefit under 35 U.S.C. §119(a) of a Korean patent application filed in the Korean Intellectual Property Office on Dec. 14, 2007 and assigned Serial No. 10-2007-0131145, the entire disclosure of which is hereby incorporated by reference.

### BACKGROUND OF THE INVENTION

1. Field of the Invention

The present invention relates to a display apparatus. More particularly, the present invention relates to a multifunctional display apparatus in which a plurality of unit display modules are united.

2. Description of the Related Art

In general, display units that are used in various types of electronic equipment are limited in size. Moreover, if it is desired to make the electronic equipment using a display unit portable and slim, the display unit is even more limited in size.

For example, a portable terminal typically includes both a display unit and a key input unit while being palm-sized for handheld use. Therefore, the display unit of the portable terminal generally has a size of about 2 to 3 inches. Such a display unit has no problem in displaying a simple screen of numerals and characters. However, the same display unit fails to satisfy various advanced functions due to its size limitation. For example, in the case of moving pictures and games, the above display unit is too small to adequately satisfy the various desires of users.

Recently, electronic equipment manufactures have competed to expand such a limited display unit in a portable terminal. For example, a portable terminal has been introduced that has a display unit and additional display units connected respectively to both sides of the portable terminal. Also, a folder-type portable terminal has been introduced that has display units installed respectively in the main body and the folder. Moreover, a touchscreen-type display unit has been launched that allows for the exclusion of a keybutton unit (i.e., a data input unit) from a portable terminal.

However, the related art has a limitation in expanding the display unit of the portable terminal. That is, the related art can expand the display unit only up to about three times, thus failing to provide various transforms of display screens for execution of various functions. Accordingly, there is a need for a multifunctional display apparatus than can expand a display.

### SUMMARY OF THE INVENTION

An aspect of the present invention is to address at least the above-mentioned problems and/or disadvantages and to provide at least the advantages described below. Accordingly, an aspect of the present invention is to provide a multifunctional display apparatus that can expand a display screen without limitation.

Another aspect of the present invention is to provide a multifunctional display apparatus that can perform various transforms of a display screen for execution of various functions.

Still another aspect of the present invention is to provide a multifunctional display apparatus that can perform various transforms of a display screen for execution of various functions and can execute each function automatically after each transform.

According to an aspect of the present invention, a multifunctional display apparatus is provided. The apparatus includes two or more unit display modules each including a Liquid Crystal Display (LCD), one or more electrical connection units for coupling the two or more unit display modules in such a way that the two or more unit display modules are electrically connected to each other and are movable with respect to each other while maintaining a physical connection to at least one other unit display module and one or more sensing units installed at each of the unit display modules to sense a neighboring unit display module, wherein a function of the display apparatus is executed according to an arrangement of the two or more unit display modules as sensed by the one or more sensing units.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings in which:

FIG. 1 is a front view of a multifunctional display apparatus according to an exemplary embodiment of the present invention;

FIG. 2 is a rear view of the multifunctional display apparatus of FIG. 1;

FIG. 3 is a schematic diagram illustrating the rear structure of a unit display module of the multifunctional display apparatus according to an exemplary embodiment of the present invention;

FIG. 4 is a schematic diagram illustrating a connection between unit display modules of the multifunctional display apparatus according to an exemplary embodiment of the present invention;

FIG. 5 is a schematic diagram illustrating a structure of a unit display module according to an exemplary embodiment of the present invention;

FIG. 6 is a schematic diagram illustrating positions of sensing units between unit display modules according to an exemplary embodiment of the present invention;

FIG. 7 is a schematic diagram illustrating a structure of the multifunctional display apparatus according to an exemplary embodiment of the present invention; and

FIG. 8 is a schematic diagram illustrating a multifunctional display apparatus used as a portable terminal according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

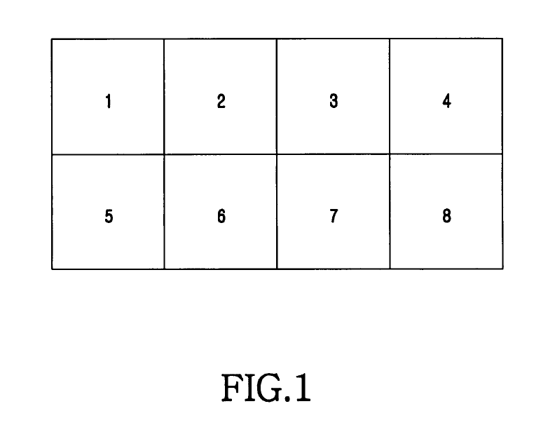

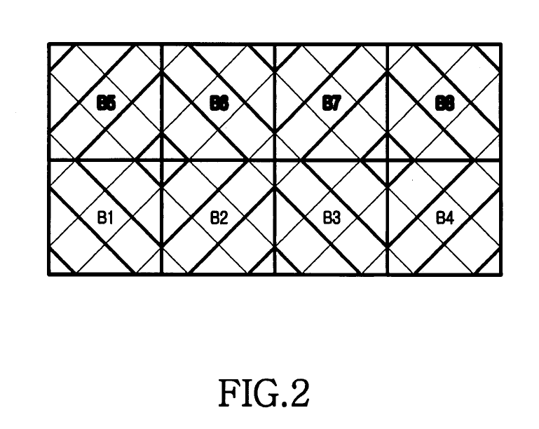

FIG. 1 is a front view of a multifunctional display apparatus according to an exemplary embodiment of the present invention and FIG. 2 is a rear view of the multifunctional display apparatus of FIG. 1.

As illustrated in FIGS. 1 and 2, a multifunctional display apparatus according to an exemplary embodiment of the present invention includes eight unit display modules. The unit display modules are connected to each other, and may be transformed into various arrangements while maintaining a connected condition. Hereinafter, for convenience of description, the eight unit display modules will be respectively referred as first to eighth unit display modules 1, 2, 3, 4, 5, 6, 7 and 8. A screen may be displayed on the front of each unit display module and each unit display module may be implemented using a touchscreen.

As illustrated in FIG. 2, a plurality of grooves are formed at the rear of the multifunctional display apparatus. Using the grooves at the rear of the apparatus, the unit display modules are connected to each other through given connection units. More specifically, thick lines on FIG. 2 denote connection units between the unit display modules. In an exemplary implementation, the connection units are also used as electrical connection units between the unit display modules. Herein, B1 to B8 denote the back side of the first to eighth unit display modules respectively.

In an exemplary embodiment which will be described in more detail below, various transforms or arrangements of the multifunctional display apparatus may be implemented using the connection units. In one exemplary implementation, the various arrangements are similar to the well-known Rubik's Cube or Rubik's magic (flip flop) puzzle.

As illustrated in FIGS. 1 and 2, an exemplary display apparatus includes eight display unit modules. However, this is not to be considered a limitation of the scope of the invention. That is, a multifunctional display apparatus according to an exemplary embodiment of the present invention may be configured to include more than or fewer than eight unit display modules. Also, as explained above, the present invention may be transformed in a fashion similar to the Rubik's Cube puzzle. However, this is also not to be considered a limitation of the invention as other types of transforms are also possible.

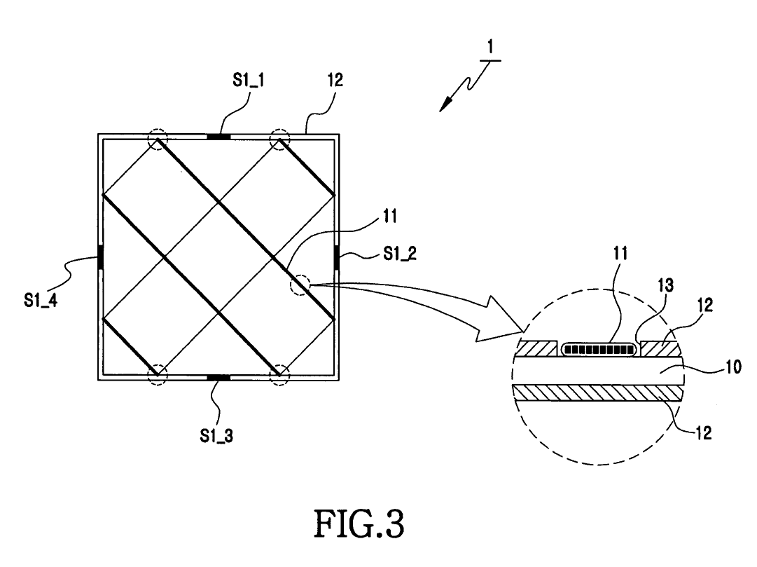

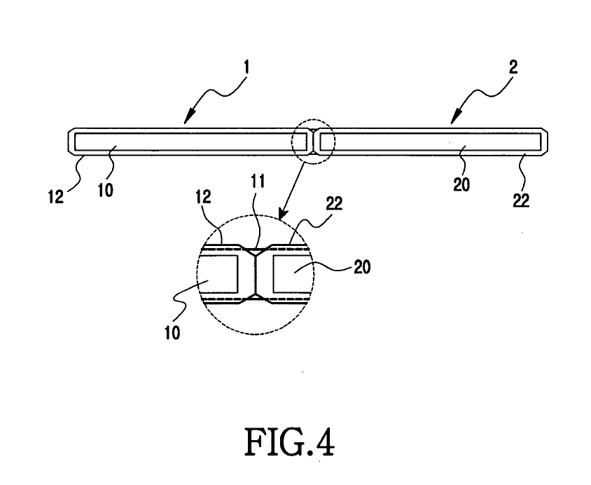

FIG. 3 is a schematic diagram illustrating the rear structure of a unit display module of a multifunctional display apparatus according to an exemplary embodiment of the present invention. FIG. 4 is a schematic diagram illustrating a connection between unit display modules of a multifunctional display apparatus according to an exemplary embodiment of the present invention. Although only the rear structure of the first unit display module 1 is illustrated in the drawings, the other unit display modules may have the same structure.

Referring to FIG. 3, an electrical connection unit 11 is coupled to the rear B1 of the first unit display module 1. In an exemplary implementation as illustrated, the electrical connection unit 11 may be coupled to the first unit display module 1 in a diagonal direction. Of course, the electrical connection unit 11 may also be coupled to the unit display module in other directions such as in a horizontal direction or a vertical direction or a combination of the two. The electrical connection unit 11 provides an electrical connection between the unit display modules, prevents the separation of the unit display modules from each other and is used as a connection unit that enables the display apparatus to achieve various transformations or arrangements. That is, although not illustrated in FIG. 3, the connection unit 11 further includes a mechanical coupling by which the unit display modules are movable relative to each other while maintaining an electrical connection and preventing separation of the unit display modules. The mechanical coupling allows movement of the unit display modules so that the display apparatus can be configured in a variety of arrangements or transformations.

As illustrated in FIG. 3, a transparent cover 12 is installed on the top and bottom of a Liquid Crystal Display (LCD) 10 of the unit display module 1. The transparent cover 12 may be formed of a glass material, an acryl material and the like. One purpose of the transparent cover 12 is to prevent potential damage, such as a scratch on the LCD, caused by an external impact, frequent transformations of the multifunctional display apparatus and the like. In an exemplary implementation, a groove 13 having a depth is formed in the cover 12 at a location corresponding to the connection unit. That is, the connection unit may be seated in the groove 13 so that the connection unit does not protrude from the unit display module.

In an exemplary embodiment of the present invention, four electrical connection units may be used per unit display module. This is illustrated in FIG. 3 by the four thick diagonal lines spanning the unit display module 1. A portion denoted by a dotted circular line in FIG. 3 may be connected to a circuit of the LCD 10, and the other portions may be connected to one or more neighboring unit display modules.

For example, as illustrated in FIG. 4, a first unit display module 1 and a second unit display module 2 may be united by the electrical connection unit 11 so that they are not separated from each other. Similar to the first unit display module 1, the second unit display module 2 may include a cover 22. As discussed above, the cover 12 as well as the cover 22 may be formed of transparent acryl, glass material and the like. Also, the second unit display module 2 may include an LCD 20.

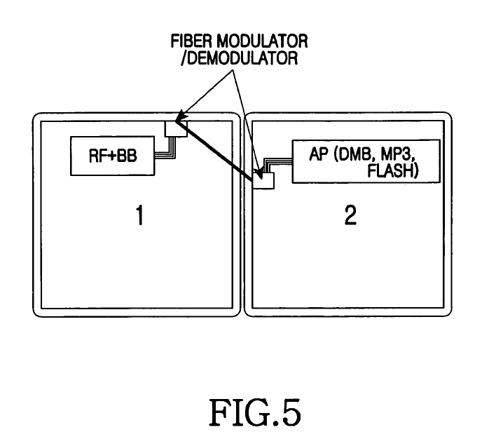

The electrical connection unit 11 may be implemented using a copper wire, a coaxial cable, a fiber-optic cable, a Flexible Printed Circuit (FPC) and the like. For example, as illustrated in FIG. 5, if a fiber-optic cable is used to implement the electrical connection unit 11, a fiber modulator/demodulator may be installed to convert an optical signal into an electrical signal.

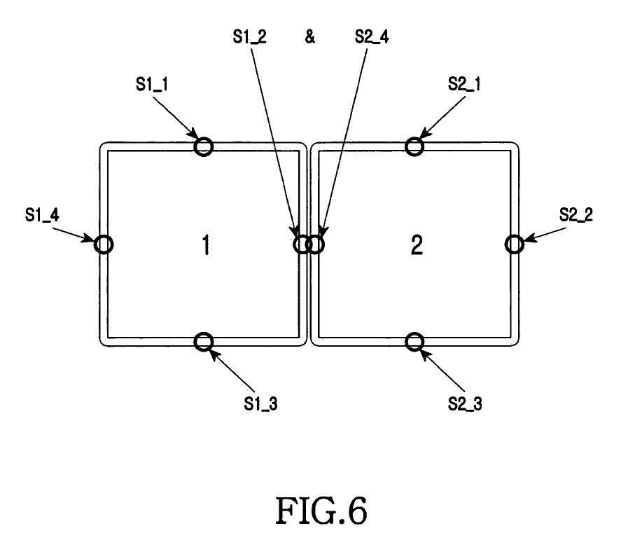

FIG. 6 is a schematic diagram illustrating positions of sensing units between unit display modules according to an exemplary embodiment of the present invention.

Referring to FIG. 6, each unit display module may be transformed with respect to the neighboring unit display module in various directions. In an exemplary implementation, the multifunctional display module may automatically detect the final transformed state and thus execute a corresponding function. Therefore, in an exemplary embodiment, each unit display module includes a sensing unit for detecting the neighboring unit display module.

In an exemplary implementation, each sensing unit includes a different and unique information value. By interpreting the information value associated with each sensing unit, information about a specific structural form of the display module can be determined. That is, the unique information value of each sensing unit can be used to determine information about a specific structural form according to a contact between the unit display modules. Various types of multifunctional display apparatuses, which will be described and illustrated later with reference to Table 2, include a form in which at least one side touches the neighboring unit display module. In an exemplary implementation, the sensing unit is installed at the center of each side of each unit display module. This installation position provides a smooth sensing operation for reading the structural form information of each unit display module. In an exemplary embodiment, the detection angle of the sensing unit may be implemented in such a way that the neighboring unit display modules are detected only within the range of about 150° to about 210°, thus making it possible to prevent a meaningless sensing operation.

The sensing unit may be implemented using a well-known sensor. For example, the sensing unit may be implemented using a hall sensor capable of sensing a specific magnetic force value. In an exemplary embodiment, a hall sensor is installed at the location of each sensing unit of each unit display module and a magnet with a specific magnetic force value is installed there around. Accordingly, a hall sensor of the neighboring target unit display module can sense the specific magnetic force value of the magnet to execute the corresponding function.

Thus, as illustrated in FIG. 3, the first unit display module may have sensing units S1_1, S1_2, S1_3 and S1_4, each having a different specific information value, installed respectively on four sides in the counterclockwise direction. Also, as illustrated in FIG. 6, the second unit display module may have sensing units S2_1, S2_2, S2_3 and S2_4, each having a different specific information value, installed respectively on four sides in the clockwise direction. The sensing units of other unit display modules may be arranged in substantially the same way as above. That is, in an exemplary display apparatus having eight unit display modules, all the unit display modules may define sensing units with specific information values of S1_1 to S8_4.

As illustrated in FIG. 6, if the first unit display module and the second unit display module are adjacent to each other, the sensing unit S1_2 of the first unit display module and the sensing unit S2_4 of the second unit display module are adjacent to each other. Accordingly, the adjacent sensing units sense each other by detecting the unique information associated with the adjacent sensing unit and determine that the corresponding sides are adjacent to each other. The different combinations of sensed values may be used to detect function information according to various transforms of the multifunction display module as shown in Table 2 below and to automatically execute a corresponding function.

Table 1 below classifies a touch screen function and a non-touch screen function according to various functions of the multifunctional display apparatus.

Also, Table 2 below illustrates exemplary embodiments according to various transformations of the multifunctional display apparatus, application fields of Table 1 according to the respective transforms and the states of the cases of a touch screen and a non-touch screen.

TABLE 1

| | Touch Screen LCD | Non-Touch LCD |
|---|---|---|
| 1. Simple Wide | 2 × 4 flat mode is used for | Substantially identical to left |
| LCD | expanded display of maximum | |
| | size and there is no input. | |
| 2. Game Device | 2 × 1, 2 × 2, 2 × 3 or 2 × 4 (full | 2 × 1, 2 × 2 or 2 × 3 display mode may |
| | display) mode using a | be used. Other units may be used |
| | touchscreen function may be | for input units (e.g., keypad and |
| | used. | control stick). |
| 3. Electronic | It may be implemented using | Substantially identical to left |
| Photo Frame | Flat mode or Folding mode. | |
| | Pictures and videos may be | |
| | represented by an electronic | |
| | photo frame having various | |
| | transforms according to user's | |
| | definitions. | |
| 4. PDA | There is no fixed display mode | There is no fixed display mode |
| | limitation, and typical mode is | limitation, and typical mode is 2 × 2 |
| | flat 2 × 2 display mode using | or 2 × 3 flat display mode. Other |
| | both sides as touch screens. | units are used for inputs. |
| 5. Mobile | There is no fixed display mode | There is no fixed display mode |
| Phone | limitation, and typical mode is | limitation, and typical mode is 2 × 1 |
| | 2 × 1 folding minimum display | folding minimum display mode. 1 |
| | mode. | upper unit is used for display and |
| | | lower unit is used as input keypad; |
| | | 2 side 2 units are used for display |
| | | and rear 2 units are used for input |
| | | units. |
| 6. DMB/Media | There is no fixed display mode | There is no fixed display mode |
| (audio, video | limitation, but typical | limitation, but typical application is |
| player) | application is 2 × 1 or 2 × 2 | 2 × 1, 2 × 2 or 2 × 3 mode. This is used |
| | mode. | for display region, and other unit is |
| | | used as input unit. |
| 7. Electronic | There is no fixed display mode | Substantially identical to left |
| Calendar | limitation, and both flat display | |
| (Clock, | mode and special mode may be | |
| Scheduler) | used to display calendar and | |
| | scheduler. | |
| 8. Multi-card | Credit card, bank card, | Substantially identical to left |
| Viewer | membership card, shopping | |
| | card, etc. When folded and | |
| | unfolded, another card is | |
| | shown; and when again folded | |
| | and unfolded, other card is | |
| | shown. | |
| 9. Portable | There is no fixed display mode | There is no fixed display mode |
| Notebook PC | limitation, and typical mode is | limitation, and typical mode is 2 × 3 |
| | 2 × 4 maximum display mode. | display mode. This is used for |
| | Some is used as display region, | display region, and other unit is |
| | and other is used as input unit. | used as input unit. |
| 10: Electronic | There is no fixed display mode | Substantially identical to left |
| Book (e-Book) | limitation, and typical mode is | |
| | 2 × 2 display mode. When | |
| | folded and unfolded, next page | |
| | is displayed. | |
| 11. Input Panel | There is no fixed display mode | Nothing related |
| (Writing Panel, | limitation. | |
| Electronic | | |
| Backboard) | | |

TABLE 2

| Pattern | | | | |
|---|---|---|---|---|
| Catepory | | Transform Pattern | Vector Set Value | Functionality |
| FLAT | 2 × 1 | 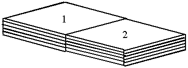 | S1_3 & S5_1, S2_3 & S6_1, S3_3 & S7_1, S4_4 & S8_1 | Non-Touch LCD: 2, 3, 4, 5, 6, 7, 8, 10 Touch LCD: 2, 3, 4, 5, 6, 7, 8, 10, 11 |
| | 2 × 2 | 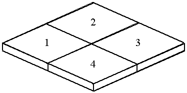 | S1_3 & S5_1, S1_2 & S2_4, S2_3 & S6_1, S5_2 & S6_4, S3_3 & S7_1, S3_2 & S4_4, S4_4 & S8_1, S7_2 & S8_4 | Non-Touch LCD: 2, 3, 4, 5, 6, 7, 8, 9, 10 Touch LCD: 2, 3, 4, 5, 6, 7, 8, 9. 10, 11 |
| | 2 × 3 | 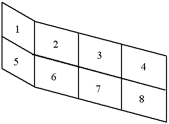 | S1_3 & S5_1, S2_2 & S3_4, S2_3 & S6_1, S3_3 & S7_1, S3_2 & S4_4, S4_4 & S8_1, S6_2 & S7_4, S7_2 & S8_4 | Non-Touch LCD: 1, 2, 3, 4, 5, 6, 7, 8, 9, 10 Touch LCD: 1, 2, 3, 4, 5, 6, 7, 8, 9. 10, 11 |
| | 2 × 4 | 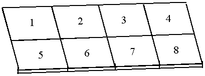 | S1_3 & S5_1, S1_2 & S2_4, S2_2 & S3_4, S2_3 & S5_1, S5_2 & S6_4, S3_3 & S7_1, S3_2 & S4_4, S4_4 & S8_1, S6_2 & S7_4, S7_2 & S8_4 | Non-Touch LCD: 1, 3, 6, 7, 10 Touch LCD: 1, 2, 3, 4, 6, 7, 9, 10, 11 |
| SPECIAL | 1 | 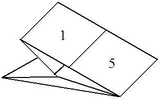 | S1_3 & S5_1, S6_2 & S7_4 | Non-Touch LCD: 3, 5, 6, 7 Touch LCD: 3, 4, 6, 7, 11 |
| | 2 | 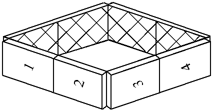 | S1_2 & S2_4, S3_2 & S4_4, S5_2 & S6_4, S7_2 & S8_4 | Non-Touch LCD: 3, 6, 7, 10 Touch LCD: 3, 6, 7, 10 |
| | 3 | 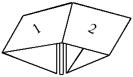 | S1_2 & S2_4, *note1 | Non-Touch LCD: 3.7 Touch LCD: 3, 7 |
| | 4 | 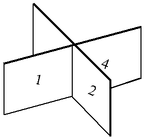 | S1_2 & S4_4 S2_4 & S6_4 S3_2 & S7_2 S5_2 & S8_4 | Star form: Non-Touch LCD: 3, 6, 7, 8 Touch LCD: 3, 6, 7, 8 |
| | 5 | 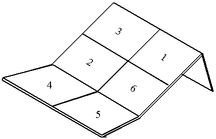 | S1_3 & S5_1, S2_2 & S3_4, S2_3 & S6_1, S3_3 & S7_1, S4_4 & S8_1, S5_2 & S7_4 | Non-Touch LCD: 1, 2, 3, 4, 6, 7, 9, 10 Touch LCD: 1, 2, 3, 4, 6, 7, 9, 10, 11 |
| | 6 | . . . | . . . | . . . |

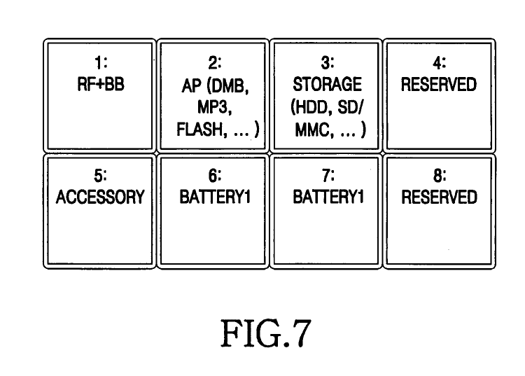

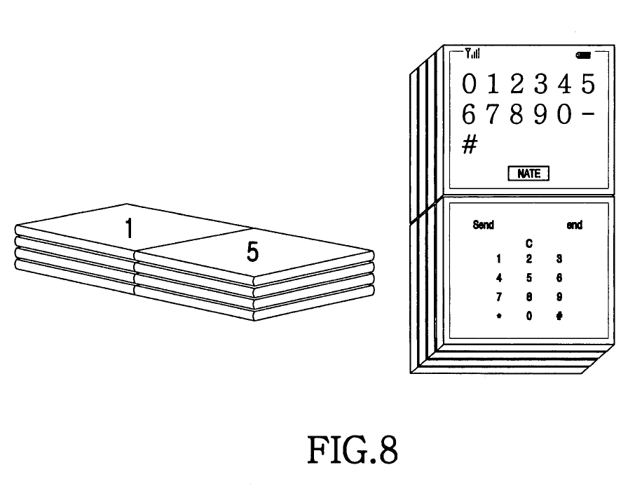

FIG. 7 is a schematic diagram illustrating a structure of a multifunctional display apparatus according to an exemplary embodiment of the present invention. FIG. 8 is a schematic diagram illustrating a multifunctional display apparatus used as a portable terminal according to an exemplary embodiment of the present invention.

According to an exemplary embodiment of the present invention, each unit display module of a multifunctional display apparatus may include only an LCD. In other exemplary embodiments, each unit display module may further include additional hardware for execution of various functions according to various transforms.

An exemplary case in which a multifunctional display apparatus is used as a portable terminal will be described with reference to Table 1, Table 2, FIG. 7 and FIG. 8.

As illustrated in FIG. 7, each unit display module may further include corresponding hardware. For example, the first unit display module may include an RF Baseband module, the second unit display module may include AP, and each additional unit display module may include a battery or an accessory or be reserved. As illustrated in FIG. 8, if a multifunctional display apparatus according to an exemplary embodiment of the present invention is transformed into a bar-type portable terminal, the first unit display module may further include a speaker unit and the fifth unit display module may further include a microphone unit.

The portable terminal application as illustrated in FIG. 8 is substantially identical to the first form of Table 2. Herein, the sensing units of the respective unit display modules respond to each other in the above-described forms. For example, the sensing unit S1_3 of the first unit display module responds to the sensing unit S5_1 of the fifth unit display module. Also, the sensing unit S2_3 of the second unit display module responds to the sensing unit S6_1 of the sixth unit display module. Similarly, the sensing unit S3_3 of the third unit display module responds to the sensing unit S7_1 of the seventh unit display module and the sensing unit S4_3 of the fourth unit display module responds to the sensing unit S8_1 of the eighth unit display module. The detection of the respective sensing units by the specific information values of the respective sensing units allows the multifunctional display apparatus to automatically operate as a portable terminal if the multifunctional display module is transformed into the above-described form.

As described above, a multifunctional display apparatus according to an exemplary embodiment of the present invention may expand a display screen without limitation, may perform various transforms of the display screen for execution of various functions, and may execute each function automatically after each transform, thus enhancing the user's convenience.

While the invention has been shown and described with reference to certain exemplary embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A multifunctional display apparatus, the apparatus comprising:
two or more unit display modules each including a Liquid Crystal Display (LCD);
one or more electrical connection units for coupling the two or more unit display modules in such a way that the two or more unit display modules are electrically connected to each other and are movable with respect to each other while maintaining a physical connection to at least one other unit display module; and
one or more sensing units installed at each of the unit display modules to sense a neighboring unit display module, wherein a function of the display apparatus is executed according to an arrangement of the two or more unit display modules as sensed by the one or more sensing units.

2. The apparatus of claim 1, wherein each of the two or more unit display modules comprises a square shape.

3. The apparatus of claim 2, wherein the one or more electrical connection units are installed at the rear of the respective unit display modules at regular intervals and in the same direction.

4. The apparatus of claim 3, wherein the same direction comprises at least one of horizontal, vertical and diagonal with respect to the rear of the respective unit display modules.

5. The apparatus of claim 2, wherein each of the two or more unit display modules further comprises a transparent cover configured in such a way that the LCD is covered with the respective transparent cover.

6. The apparatus of claim 5, wherein a groove having a certain depth is formed at the rear of the transparent cover and the one or more electrical connection units are located in the groove.

7. The apparatus of claim 6, wherein the transparent cover comprises one of a glass material and an acryl material.

8. The apparatus of claim 7, wherein the one or more electrical connection units are electrically connected to the LCD at one end of the groove, and the other end is connected to the neighboring unit display module.

9. The apparatus of claim 8, wherein the one or more electrical connection units comprise at least one of a copper wire, a coaxial cable, a fiber-optic cable and a Flexible Printed Circuit (FPC).

10. The apparatus of claim 9, wherein each of the two or more unit display modules further comprises a fiber modulator/demodulator if the fiber-optic cable is used as the one or more electrical connection unit.

11. The apparatus of claim 2, wherein each of the two or more unit display modules touches at least one edge of the neighboring unit display module independent of the arrangement of the two or more unit display modules.

12. The apparatus of claim 11, wherein the one or more sensing units are respectively installed at the centers of four sides of each unit display module.

13. The apparatus of claim 12, wherein the one or more sensing units comprise specific information values for the respective sides to execute a corresponding function according to various arrangements of the respective unit display modules.

14. The apparatus of claim 13, wherein the one or more sensing units comprise a hall sensor that senses a specific magnetic force value of a magnet installed on each side of each unit display module.

15. The apparatus of claim 14, wherein a detection angle of the one or more sensing units is implemented in such a way that the neighboring unit display modules are detected only within the range of about 150° to about 210°.

16. The apparatus of claim 1, wherein the number of the two or more unit display modules is eight.

17. The apparatus of claim 16, wherein the eight display modules are configured in at least one of a 2×1 arrangement, a 2×2 arrangement, a 2×3 arrangement and a 2×4 arrangement.

18. The apparatus of claim 1, wherein each of the two or more unit display modules further comprises at least one of a Radio Frequency (RF) baseband module, a battery, an accessory and a storage module.
